(19) United States
(12) Patent Application Publication
(10) Pub. No.: US 2005/0254546 A1
(43) Pub. Date: Nov. 17, 2005

(54) System and method for segmenting crowded environments into individual objects

(75) Inventors: Jens Rittscher, Schenectady, NY (US); Timothy Patrick Kelliher, Scotia, NY (US); Peter Henry Tu, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/942,056

(22) Filed: Sep. 16, 2004

Related U.S. Application Data
(60) Provisional application No. 60/570,644, filed on May 12, 2004.

(51) Int. Cl. G06F 7/00

(52) U.S. Cl. 374/1

(57) ABSTRACT

A crowd segmentation system and method is described. The system includes a digital video capturing subsystem and a computing subsystem. The computing subsystem utilizes an emergent labeling technique to segment a crowd into individuals. The emergent labeling technique employs algorithms which can be used iteratively to place vertices associated with feature points in a captured digital video image into multiple cliques and, ultimately, in a single clique.

### CROSS REFERENCE TO RELATED APPLICATIONS

This application claims the benefit of U.S. provisional application No. 60/570,644 filed May 12, 2004, which is incorporated herein in its entirety by reference.

The invention relates generally to a system and method for identifying discrete objects within a crowded environment, and more particularly to a system of imaging devices and computer-related equipment for ascertaining the location of individuals within a crowded environment.

There is a need for the ability to segment crowded environments into individual objects. For example, the deployment of video surveillance systems is becoming ubiquitous. Digital video is useful for efficiently providing lengthy, continuous surveillance. One prerequisite for such deployment, especially in large spaces such as train stations and airports, is the ability to segment crowds into individuals. The segmentation of crowds into individuals is known. Conventional methods of segmenting crowds into individuals utilize a model-based object detection methodology that is dependent upon learned appearance models.

Also, automatic monitoring of mass experimentation on cells involves the high throughput screening of hundreds of samples. An image of each of the samples is taken, and a review of each image region is performed. Often, this automatic monitoring of mass experimentation relates to the injection of various experimental drugs into each sample, and a review of each sample to ascertain which of the experimental drugs has given the desired effect.

### BRIEF DESCRIPTION OF THE DRAWINGS

FIGS. 1(A)-(C) illustrate the evolution of cliques in accordance with an exemplary embodiment of the invention.

FIGS. 2(A)-(C) illustrate the segmentation of a crowd into individuals in accordance with an exemplary embodiment of the invention.

FIGS. 3(A)-(E) illustrate the clustering and evolution of cliques to provide segmentation of a crowd into individuals in accordance with an exemplary embodiment of the invention.

FIGS. 4(A)-(C) illustrate the clustering and evolution of cliques to provide segmentation of a crowd into individuals in accordance with an exemplary embodiment of the invention.

FIG. 5 is a schematic representation of a crowd segmentation system constructed in accordance with an exemplary embodiment of the invention.

FIGS. 6(A) and (B) illustrate initial and final binary matrices in accordance with an aspect of the invention.

FIG. 7 illustrates a system for segmenting a crowded environment into individual objects in accordance with an exemplary embodiment of the invention.

### SUMMARY

One exemplary embodiment of the invention is a system for segmenting crowded environments into individual objects. The system includes an image capturing subsystem and a computing subsystem. The computing subsystem utilizes an emergent labeling technique to segment a crowded environment into individual objects.

One aspect of the exemplary system embodiment is that the image capturing subsystem is a digital video capturing that is configured to detect feature points of objects of interest.

Another exemplary embodiment of the invention is a method for segmenting a crowded environment into individual objects. The method includes the steps of capturing an image of a crowded environment, detecting feature points within the image of the crowded environment, associating a vertex with each of the feature points, and assigning each vertex with a single clique.

Another exemplary embodiment of the invention is a method for segmenting an environment having multiple objects into individual objects. The method includes the steps of digitally capturing an image of an environment having multiple objects, detecting feature points within the image of the multiple objects, associating a vertex with each of the feature points, and assigning each vertex to a single clique and thereby segmenting individual objects from the multiple objects.

These and other advantages and features will be more readily understood from the following detailed description of preferred embodiments of the invention that is provided in connection with the accompanying drawings.

### DETAILED DESCRIPTION OF EXEMPLARY EMBODIMENTS

An alternative methodology to the conventional methods for segmenting crowded environments into individual objects includes utilizing an emergent labeling technique that makes use of only low-level interest points. The detection of objects of interest, such as, for example, individuals in a crowded environment, is formulated as a clustering problem. Feature points are detected, via the use of an imaging device, such as, for example, a digital video device such as a digital camera or a scanner or other analog video medium in conjunction with an analog-to-digital converter. The feature points are associated with vertices of a graph. Two or more vertices are connected with edges, based on the plausibility that the two vertices could have been generated from the same object, to form clusters. A cluster is a grouping of vertices in which each of the vertices is connected by an edge with at least one other vertex. From the clusters, cliques are identified. Cliques are a subset of clusters and are groupings of vertices in which all the vertices are connected to all the other vertices in the grouping.

The main goal in image measurement is the identification of a set of interest points, V={vᵢ}, that can be associated in a reliable way with objects of interest, such as, for example, individuals. As a first step, a probabilistic background model is generated. Then, image locations indicating high temporal and/or spatial discontinuity are selected as feature points. Each feature point is associated with a vertex plottable on a graph G. There exists an edge eᵢⱼ between a pair of vertices vᵢ and vⱼ if and only if it is possible that the two vertices could have been generated by the same individual. The strength aᵢⱼ of the edge eᵢⱼ may be considered a function of the probability that the two connected vertices belong to the same individual. Alternatively, the strength aᵢⱼ also may be a function of a given clique.

Given the vertices embedded in a graph G, a goal is to determine the true state of the system. This issue is compounded in that (1) the number of individual objects in the scene is unknown, and (2) if there is little separation between individual objects, the inter-cluster edge strengths could be as strong as the intra-cluster edge strengths. Under crowded situations, conventional clustering algorithms, such as k-means and normalized cut, may not be useful, since such clustering algorithms presume that intra-cluster edge strengths are considerably stronger than inter-cluster edge strengths.

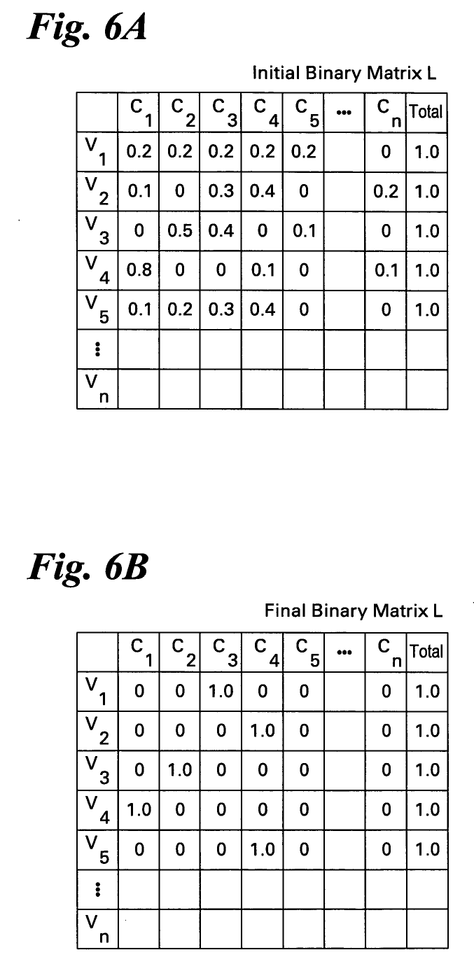

Instead, an emergent labeling algorithm may be used. For a set of vertices within a clique c, there exists a line between every pair of the vertices in c. A maximal clique cₘₐₓ on graph G is a clique that is not a subset of any other clique on graph G. In the emergent labeling algorithm, each vertex cluster in the estimate of the true state must be a clique on the graph G. The assignment of each vertex to a clique may be represented by a binary matrix L (FIG. 6(A)), where if vᵢ is assigned to cⱼ then Lᵢⱼ=1, otherwise Lᵢⱼ=0. Since each vertex can be assigned to only one maximal clique cₘₐₓ, the sum of all elements of each row of L must equal one.

It has been observed that making vertex assignment decisions based solely on local context can be confusing. A global score function S(L) is utilized such that vertex assignment decisions are made on both local and global criteria. One criterion for judging the merit of a cluster is to take the sum of the edge strengths connecting all the vertices inside the cluster. The global score function S(L) can be computed from the following:
S(L)=trace(L′AL)
where A is an affinity matrix such that aᵢⱼ is equal to the edge strength of edge eᵢⱼ. The assignment matrix L defines a sub graph of G where all edges that connect vertices that have been assigned to different cliques are removed. The global score function S(L) essentially is the sum of the edge strengths in that sub graph.

Next, the optimal labeling matrix L must be found with respect to the optimization criteria S. Optimal labeling matrix L is initially viewed as a continuous matrix so that each vertex can be associated with multiple cliques. After several iterations, the matrix is forced to have only binary values. For iteration t+1, a soft assign procedure will be used as follows:
rᵢⱼ(t+1)=e^{βdS(L(t))/dLij}
The derivative dS(L(t))/dLij=AᵢLⱼ(t) where Aᵢ is the i^{th} row of A and Lⱼ(t) is the j^{th} column of L(t). If the vertex vᵢ is not a member of clique cⱼ, then rᵢⱼ(t+1)=0, and the label coefficient equations is now defined as:
Lᵢⱼ(t+1)=rᵢⱼ(t+1)/Σₖrᵢₖ(t+1).
Initially, all label values for each vertex are uniformly distributed among the available cliques (FIG. 6(A)). After each iteration, the value of β increases, and thus the label for the dominant clique for each vertex gets closer to one and the rest of the labels approach zero (FIG. 6(B)). The optimal label matrix, as β approaches infinity, is then estimated to be defined as:
Lₒₚₜ=lim L_{β}.

The aforementioned soft assign technique propagates assignment from high to low certainty across the graph. If a vertex is a member of a large number of maximal cliques, then based on local context there is much ambiguity. This occurs most often for vertices that are in the center of the foreground pixel cluster. Vertices near the periphery of the cluster, on the other hand, may be associated with a relatively small number of cliques. These lower ambiguity vertices help strengthen their chosen cliques. As these cliques get stronger through iterations, they begin to dominate and attract the remaining less certain vertices. This weakens neighboring cliques which lowers the ambiguity of vertices in the region.

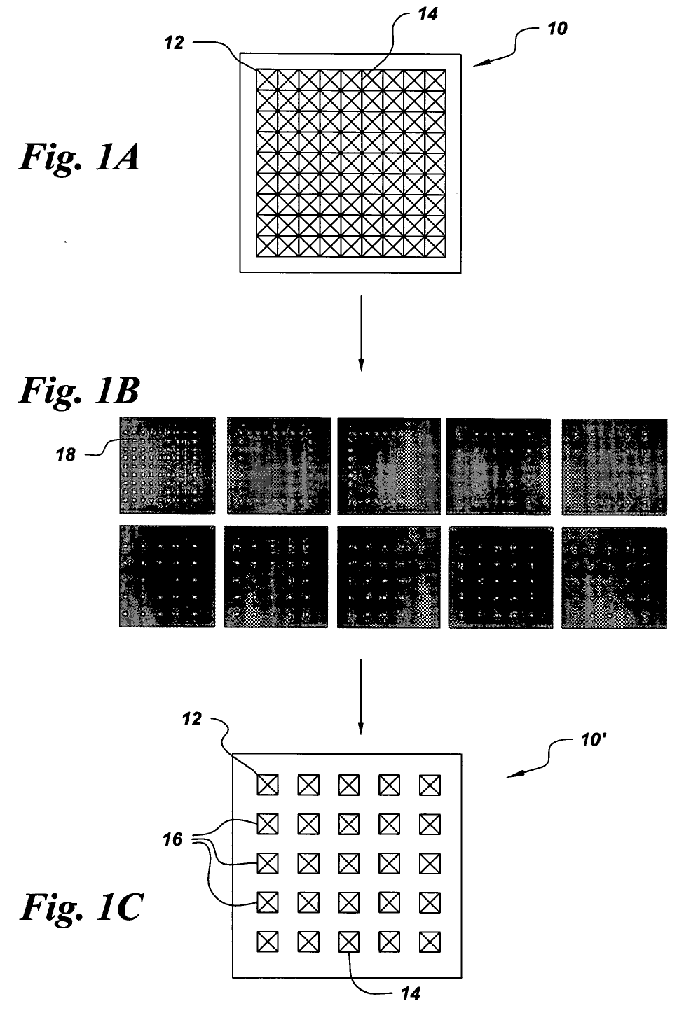

Referring now to FIGS. 1(A)-(C), there is shown, via a synthetic experiment, the evolution of clique strength over time through the use of the soft assign technique. FIG. 1(A) shows an initial graph structure 10 in which all the vertices 12 are connected to adjacent vertices 12 with edges 14. FIG. 1(A) is essentially the initial grouping of all the vertices into a cluster. FIG. 1(B) shows the evolution of cliques from the cluster shown in the initial graph structure 10. The top left graph of FIG. 1(B) shows the clique centers 18, while the remaining graphs in FIG. 1(B) illustrate the evolution of clique strength over time. FIG. 1(C) illustrates the identified cliques 16 in the final graph structure 10′.

People are, on the whole, roughly the same height and stand perpendicular to the ground. As such, the foot plane and the head plane can be defined. Two homographies, H_{f} and Hₕ, map the imaging planes for, respectfully, the foot and the head. If foot pixels p_{f} and head pixels pₕ identified from a camera or other video medium are from the same person and the person is assumed to be standing perpendicular to the floor, then:
HₕpₕαH_{f}p_{f}.
Further, a mapping between the foot pixel p_{f} and the head pixel pₕ can be defined as:
pₕαHₕ⁻¹H_{f}p_{f}.

An aspect of the invention may be separating pixels into foreground pixels and background pixels. When considering a foreground pixel clustering, the center pixel is set to a foot pixel, and the head pixel is determined via the homography Hₕ⁻¹H_{f}. The height vector runs from the foot pixel to the head pixel. From an overhead angle, the width of each individual is assumed to be relatively constant. The width vector is set to be perpendicular to the height vector. By warping a local image, the individuals can be contained in a width w by height h bounding box. Head to foot mapping is valid given a minimum of four head to foot pixel pairs.

A set of maximal cliques is to be determined from the clustering. Maximal cliques are those cliques in which respective vertices are correctly identified as belonging in their respective cliques. Conceptually, if a window that is sized w by h is placed in front of the foreground patch, the vertices inside the window constitute a clique. Upon any change in the set of interior vertices, a new clique is formed.

Given a partitioning function Ω, a vertex for each partition may be defined by the equation:
vᵢ=max v_{εΩi}|▾|I−B*φ_{δ}|(v),
where φ_{δ} is a suitable band pass filter, I is the current image, and B is the background image. Vertices having a value below a given threshold are rejected from a particular clique. An orientation vector is associated with each vertex, and it is computed directly from the gradient of the absolute difference image. It is presumed that the background surrounds most individuals, and it is also assumed that most vertices are located on the boundary of an individual. Since the absolute difference is computed, the vertices located at the boundary of each individual should be pointing toward the center of the individual.

To determine edge strength between two vertices, it may be assumed that both of the vertices are on the periphery of an individual's outline. From an overhead vantage point, each individual's shape is determined to be roughly circular. Since the orientation of each vector should be pointing toward the center of the individual, the following model is defined:
ωⱼ=π−ωᵢ+2ωᵢⱼ,
where ωⱼ is the orientation of the vertex i, ωⱼ is the orientation of the vertex j, and ωᵢⱼ is the orientation of the line between the vertices i and j. The strength aᵢⱼ of the edge eᵢⱼ may be defined as:
aᵢⱼ=1.0−|ωⱼ−(π−ωᵢ+2ωᵢⱼ)|/π
It should be appreciated that this is only one way to ascertain the strength aᵢⱼ. One alternative way is to define more meaningful descriptors for vertices, such as head vertices and limb vertices. Classifiers on types of vertices and edge strength aᵢⱼ would represent consistency between the spatial relationship of vertices and the type of classification.

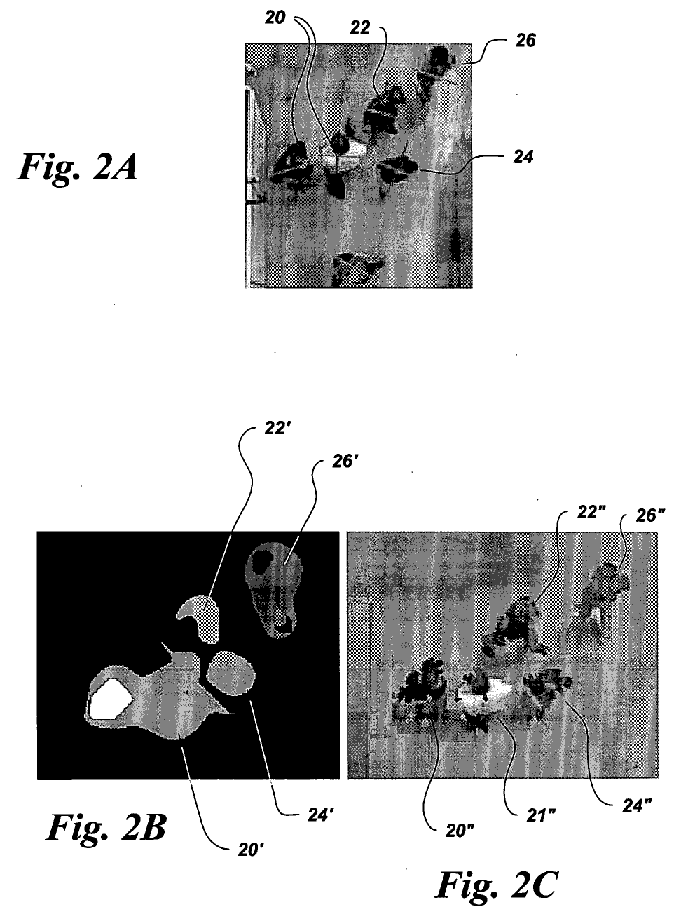

With specific reference to FIGS. 2(A)-(C), a foreground patch is broken up into clusters, and eventually, into maximal cliques. FIG. 2(A) illustrates a view from overhead of groupings of vertices 20, 22, 24, and 26. FIG. 2(B) illustrates clusters 20′, 22′, 24′, and 26′ formed from, respectively, the groupings of vertices 20, 22, 24, and 26. Finally, individual vertices are mapped over the image in the identification of maximal cliques 20″, 20″, 22″, 24″, and 26″ in FIG. 2(C).

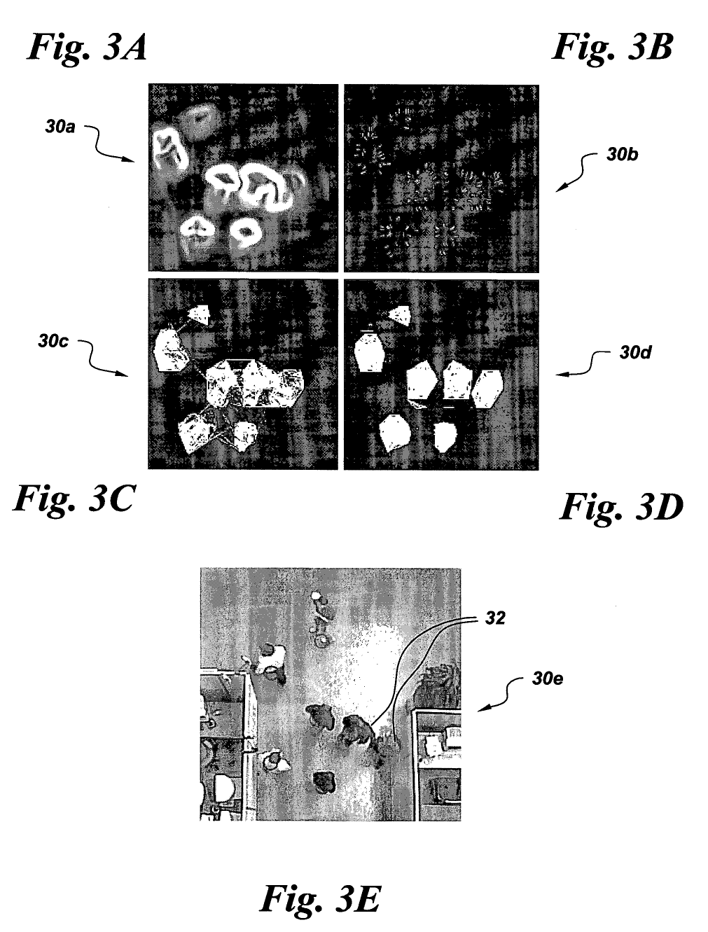

An example of the emergent labeling paradigm is shown in FIGS. 3(A)-(E). A rectified image is generated using the foot to head transform Hₕ⁻¹H_{f}p_{f}. The gradient of the absolute background difference image is calculated and shown as 30a (FIG. 3(A)) and the oriented vertices are extracted and shown as 30b (FIG. 3(B)). An initial edge strength for the graph is shown as 30c in FIG. 3(C), while a final edge strength for the graph is shown as 30d in FIG. 3(D). The resulting state of the emergent labeling algorithm is shown as 30e in FIG. 3(E). One of the challenging problems is that the right hand pair of people 32 are close to one another, and the inter edge strengths between the vertices of these two individuals is strong, making it difficult for standard clustering algorithms to function properly.

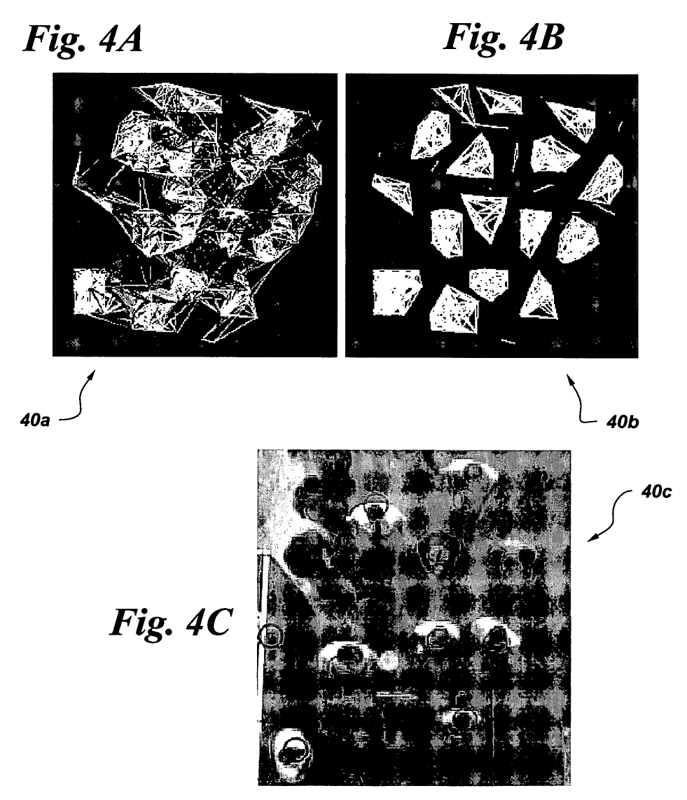

FIGS. 4(A)-(C) also illustrate an extremely crowded case. An initial edge strength for the graph is shown as 40a in FIG. 4(A), while a final edge strength for the graph is shown as 40b in FIG. 4(B). The resulting state of the emergent labeling algorithm is shown as 40c in FIG. 4(C).

The partitioning function L and the associated state X are computed deterministically. It is the uncertainty of which interest points are associated with foreground objects and their orientation that needs to be captured. Shadow regions may cause any number of interest points, and the orientation of each vertex can be misleading. Thus, an acceptance probability that a vertex vᵢ, given the magnitude of its response r, is a foreground vertex should be derived. The acceptance probability can be written as:
p(vεF|r)=p(r|vεF)p(F)/p(r).
F denotes the foreground area. The distributions p(r|vεF), p(F), and p(r) are estimated from training data. The orientation confidence estimate is based on the background/foreground separation of the pixels. The confidence is based on the minimal distance to a background pixel location.

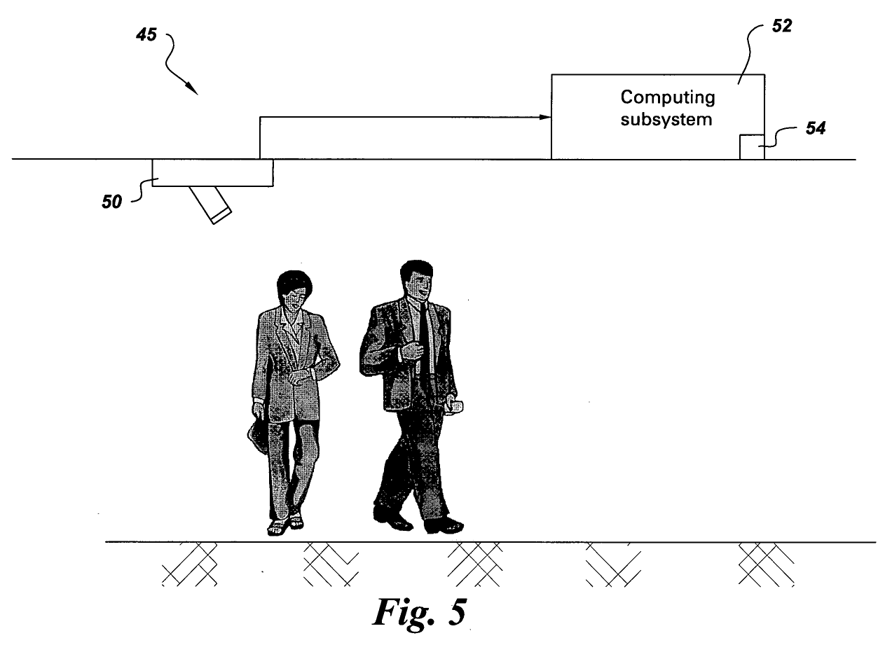

FIG. 5 schematically illustrates a segmentation system 45 that includes an image capturing device 50, such as a digital video camera or a scanner and an analog-to-digital converter, and a computing subsystem 52. The computing subsystem 52 includes a computing component 54 that performs the calculations necessary for distinguishing foreground from background and to identify individuals within crowds.

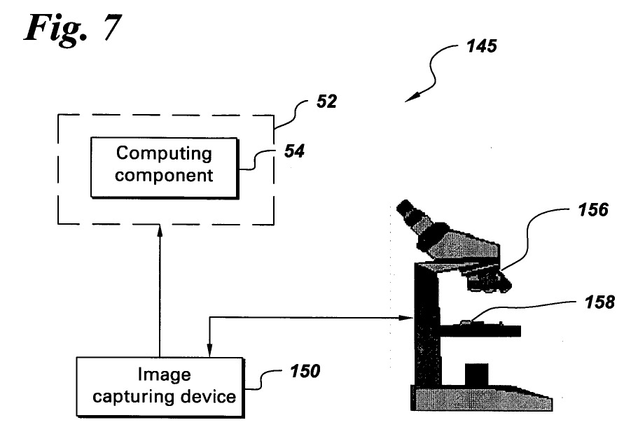

Although embodiments of the invention have been illustrated and described in terms of segmenting crowds into individual people, it should be appreciated that the scope of the invention is not that restrictive. For example, FIG. 7 illustrates another embodiment of the invention. A segmentation system 145 is shown including an image capturing device 150, a microscope 156, and a computing subsystem 52. The computing subsystem 52 includes a computing component 54. A sample 158 is placed in front of the viewer of the microscope 156. The image capturing device 150 captures the image of a region of the sample 158. The image capturing device 150 may be either digital format or analog format in conjunction with an analog-to-digital converter. The digitized image captured by the image capturing device 150 is then transferred to the computing subsystem 52. The computing component 54 performs the calculations necessary to identify individual cells within the region of the sample 158 captured. It is unnecessary to separate foreground and background regions, since everything within the region of the sample 158 captured is foreground.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for segmenting crowded environments into individual objects, comprising:
an image capturing subsystem; and
a computing subsystem, wherein said computing subsystem utilizes an emergent labeling technique to segment a crowded environment into individual objects.

2. The system of claim 1, wherein said image capturing subsystem is configured to detect feature points of objects of interest.

3. The system of claim 2, wherein said computing subsystem includes a computing component.

4. The system of claim 3, wherein said computing component is configured to associate the feature points with vertices of a graph.

5. The system of claim 4, wherein said computing component is configured to collect two or more of the vertices into one or more cliques.

6. The system of claim 5, wherein said computing component is configured to assign each of the vertices to a single clique.

7. The system of claim 6, wherein assignment of each of the vertices to a single clique is accomplished with a soft assign technique.

8. The system of claim 7, wherein the computing component assigns the vertices to cliques through the use of both local context and a global score function.

9. The system of claim 7, wherein the soft assign technique is utilized iteratively to accomplish assignment of each of the vertices in a single clique.

10. The system of claim 1, wherein said image capturing subsystem comprises a digital camera.

11. The system of claim 1, wherein said image capturing subsystem comprises an analog image capturing device and an analog to digital converter.

12. The system of claim 11, wherein said analog image capturing device comprises a scanner.

13. The system of claim 1, where said image capturing subsystem comprises a microscope.

14. A system for segmenting crowded environments into individual objects, comprising:
a digital image capturing subsystem configured to detect feature points of objects of interest; and
a computing subsystem, wherein said computing subsystem utilizes an emergent labeling technique to segment a crowded environment into individual objects.

15. The system of claim 14, wherein said computing subsystem includes a computing component.

16. The system of claim 15, wherein said computing component is configured to associate the feature points with vertices of a graph.

17. The system of claim 16, wherein said computing component is configured to collect two or more of the vertices into one or more cliques.

18. The system of claim 17, wherein said computing component is configured to assign each of the vertices to a single clique.

19. The system of claim 18, wherein assignment of each of the vertices to a single clique is accomplished with a soft assign technique.

20. The system of claim 19, wherein the computing component assigns the vertices to cliques through the use of both local context and a global score function.

21. The system of claim 19, wherein the soft assign technique is utilized iteratively to accomplish assignment of each of the vertices to a single clique.

22. The system of claim 14, further comprising a microscope in communication with said digital image capturing subsystem.

23. A method for segmenting a crowded environment into individual objects, comprising:
capturing an image of a crowded environment;
detecting feature points within the image of the crowded environment;
associating a vertex with each of the feature points; and
assigning each vertex to a single clique.

24. The method of claim 23, wherein said capturing an image is accomplished with a digital image capturing device.

25. The method of claim 23, wherein said capturing an image is accomplished with an analog image capturing device and an analog-to-digital converter.

26. The method of claim 25, wherein said analog image capturing device comprises a scanner.

27. The method of claim 23, wherein said capturing an image is accomplished with a microscope.

28. The method of claim 27, wherein said capturing an image is further accomplished with an analog-to-digital converter.

29. The method of claim 23, wherein said assigning each vertex comprises utilizing a soft assign technique.

30. The method of claim 29, wherein the soft assign technique uses both a local context and a global score function.

31. The method of claim 30, further comprising using an optimal labeling matrix to iteratively assign each vertex to a single clique.

32. A method for segmenting an environment having multiple objects into individual objects, comprising:
digitally capturing an image of an environment having multiple objects;
detecting feature points within the image of the multiple objects;
associating a vertex with each of the feature points; and
assigning each vertex to a single clique and thereby segmenting individual objects from the multiple objects.

33. The method of claim 32, wherein said digitally capturing an image is accomplished with a digital camera.

34. The method of claim 32, wherein said digitally capturing an image is accomplished with an analog image capturing device and an analog to digital converter.

35. The method of claim 34, wherein said analog image capturing device comprises a scanner.

36. The method of claim 32, wherein said digitally capturing an image is accomplished with a microscope.

37. The method of claim 36, wherein said digitally capturing an image is further accomplished with an analog to digital converter.

38. The method of claim 32, wherein said assigning each vertex comprises utilizing a soft assign technique.

39. The method of claim 38, wherein the soft assign technique uses both a local context and a global score function.

40. The method of claim 39, further comprising using an optimal labeling matrix to iteratively assign each vertex to a single clique.

41. The method of claim 32, wherein said detecting feature points comprises:
generating a probabilistic background model; and
selecting high temporal and/or high spatial discontinuity image locations as the feature points.

42. The method of claim 32, wherein the number of multiple objects is unknown.
